(19) United States
(12) Patent Application Publication
(10) Pub. No.: US 2007/0210690 A1
(43) Pub. Date: Sep. 13, 2007

(54) Shockproof device for cathode-ray tube frame/mask set

(76) Inventor: Pierluigi Testa, Roma (IT)

Correspondence Address: Joseph S Tripoli;Thomson Licensing Inc, Patent Opeartions, P O Box 5312, Princeton, NJ, 08543-5312, US

(21) Appl. No.: 10/554,455

(22) PCT Filed: Apr. 29, 2004
(86) PCT No.: PCT/FR04/50177

§ 371 Date: Jul. 27, 2006

(30) Foreign Application Priority Data
May 9, 2003 (IT) MI2003A000935

(51) Int. Cl. H01J 29/80; G06F 1/16

(52) U.S. Cl. 313/404; 361/682

(57) ABSTRACT

Colour cathode ray tube comprising a colour selection mask tensioned in at least one direction within a metal frame, the said frame comprising, on at least two opposite sides of the mask, vibration damping means of the type comprising a cavity enclosing a mass free to move in the said cavity.

The present invention relates to a masking device for a colour cathode ray tube. The invention finds its application in any type of tube comprising a colour selection mask and is just as suitable for tubes with a mask maintained in tension by the frame on which it is integrated, as for the mask formed by pressing then attached by welding to the frame assembly.

Conventional cathode ray tubes comprise a colour selection mask situated at a precise distance from the inside of the glass front face of the tube, front face on which networks of red, green and blue luminophores are laid to form a screen, the said front face being almost perpendicular to the longitudinal axis Z of the tube,

The mask is constituted by a metal sheet pierced in the middle part with many holes or slots. An electron gun arranged inside the rear part of the tube generates three electronic beams in the direction of the front face. An electromagnetic deflection device, generally located outside the tube and close to the electron gun has the function of deviating the electronic beams so as to get them to sweep the surface of the panel on which the luminophore networks are arranged. Under the influence of three electronic beams each corresponding to a determined primary colour, the luminophore networks reproduce colour pictures on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded. The frame/mask assembly is mounted in the front face using suspension means most frequently welded on the frame and co-operating with lugs inserted into the glass constituting the front face of the tube.

Tubes with the front face increasingly flat correspond to the current trend, with an evolution towards completely flat front faces To realise tubes comprising such a front face, there is a technology consisting of the use of a flat mask, maintained in tension according to at least one direction. Such structures are described for example in the American U.S. Pat. No. 4,827,179.

More conventionally, the mask can be formed by pressing, its surfaces pierced with openings then being slightly curved to follow the internal curve of the glass front face of the tube. The peripheral flange of the mask, formed so as to be perpendicular to the surface pierced with openings, is conventionally welded to the edge of the frame assembly, which generally has a noticeably L-shaped cross-section.

The colour selection mask comprising a metal sheet of very low thickness, its activation can create spurious vibrational phenomena of the said mask during the operation of the tube. Under the influence of external shock or mechanical vibrations, for example, acoustic vibration due to the loud-speakers of the television set in which the tube is inserted, the mask can begin to vibrate according to its own resonant frequency. The consequences of the vibrations of the mask modify the landing zone of the electron beams on the screen of the tube, the points of impact of each beam being thus offset with respect to the associated luminophore network, thus creating a decolouration of the picture produced on the screen.

The phenomenon can also arise for a mask formed by pressing as the almost flat surface does not have enough mechanical strength to be unaffected by vibrational phenomena generated in the tube environment.

The U.S. Pat. No. 4,827,179 proposes to add a damping means for the vibration of the mask onto one face of the mask. These means are arranged in a known manner on the peripheral part of the mask not pierced with openings. However the damping devices implemented in this patent have a complicated structure, difficult to implement. Indeed, these devices must be installed on the surface of the mask when it is tensioned on the frame; indeed the fragility of the thin metal sheet pierced with openings constituting the mask does not enable additional components to be fitted on it before it has been installed on the frame. However, here again, the fragility of the mask can pose a problem for welding damping means onto its surface: any final modification of the surface of the mask can cause the entire masking device to be rejected. Moreover, when damping elements are soldered onto the edges of the mask, weld projections can be produced and block the holes of the central mask surface, which also causes the masking device assembly to be rejected.

One of the purposes of the said invention is to propose a cathode ray tube comprising a colour cathode ray tube masking device at low cost, and easy to fit without deteriorating the surface of the mask and suitable for a tensioned mask assembly as well as a mask formed by pressing.

For this, the cathode ray tube according to the invention comprises a colour selection mask in the form of a metal sheet, adapted to be fixed on a noticeably rectangular frame assembly and comprising a pair of short parallel sides and a pair of long parallel sides, the frame/mask assembly being arranged inside the glass front face of the tube,

the frame being characterized in that at least two of the opposite sides comprise at least one cavity within which at least one metal mass is capable of moving.

The invention will be better understood from the following description and drawings, wherein:

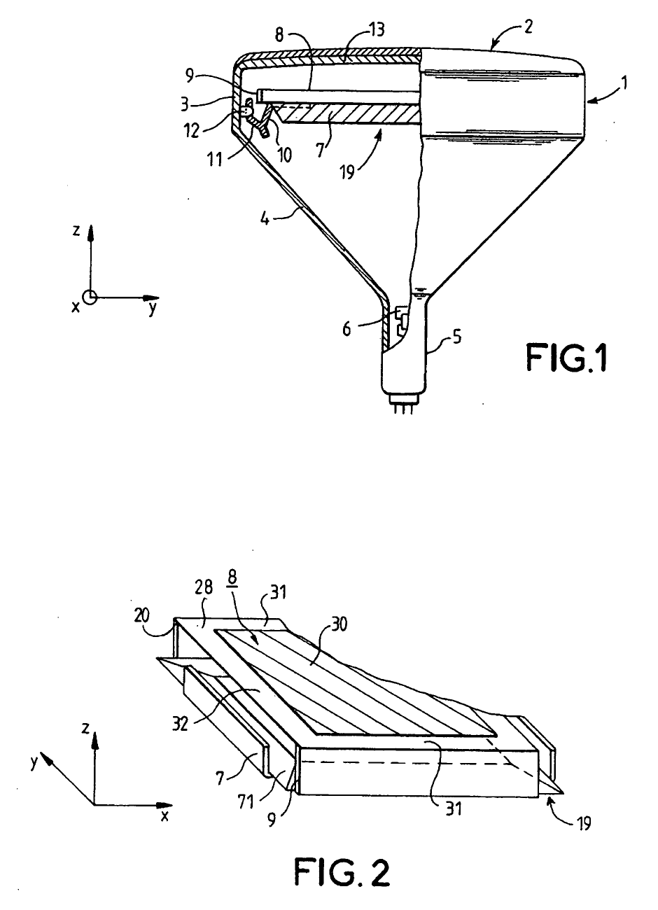

FIG. 1 is a partially exploded view of a cathode ray tube

FIG. 2 describes a frame/tensioned mask assembly according to prior art with no vibration damper

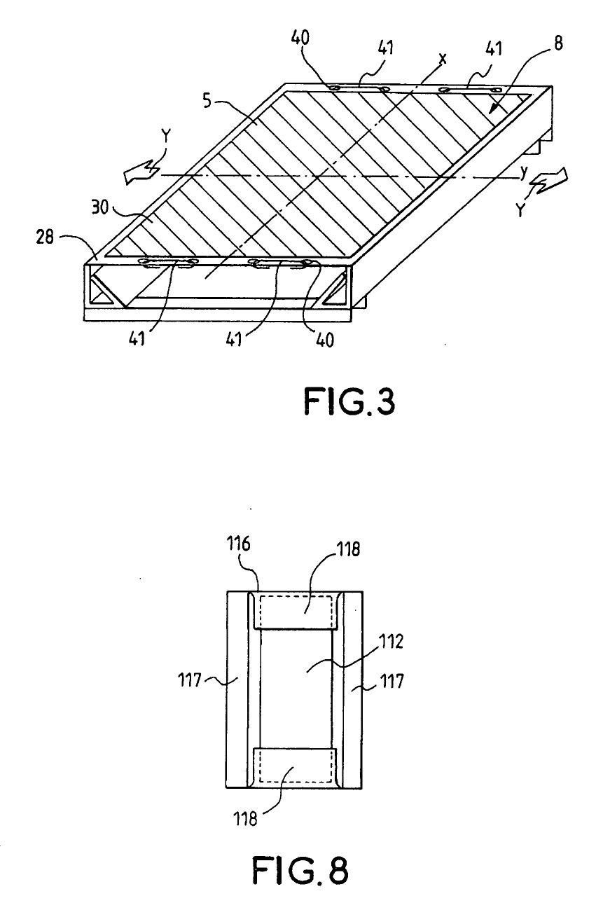

FIG. 3 is a perspective view of an embodiment of a vibration damping device according to prior art.

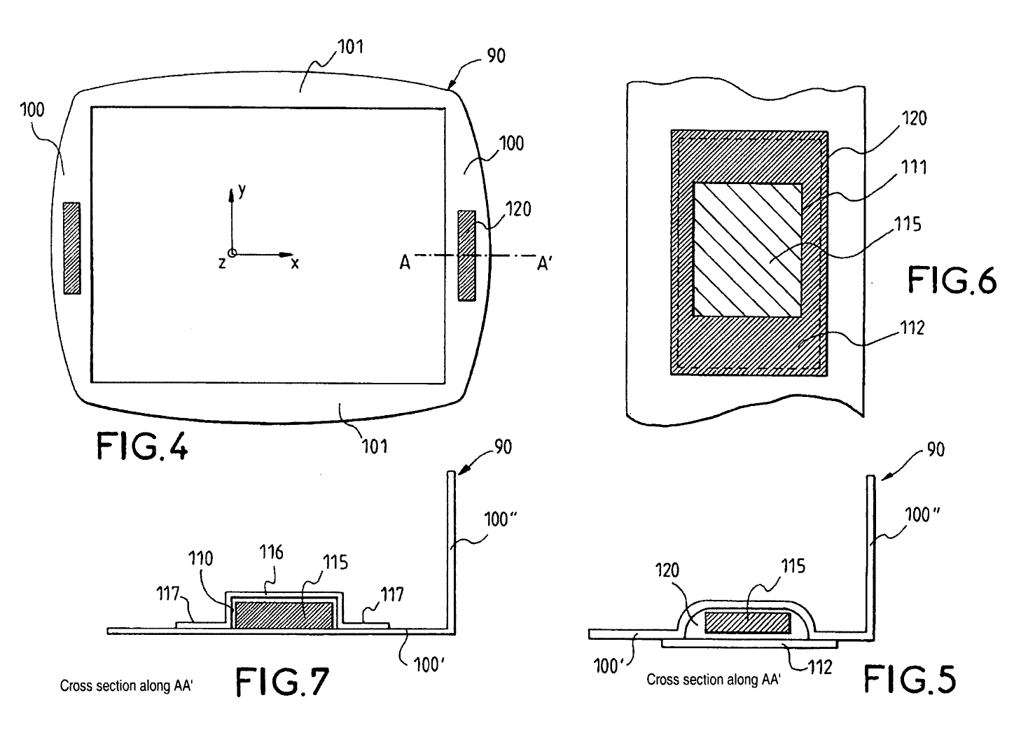

FIG. 4 shows a front view of a mask frame assembly according to the invention

FIGS. 5 and 6 illustrate details of a first embodiment of the invention

FIGS. 7 and 8 illustrate details of an alternative embodiment of the invention

As shown in FIG. 1, a cathode ray tube 1 according to the invention includes a noticeably flat panel 2 and a peripheral flange 3. The panel is connected to the rear part of the tube, in the form of a funnel 4 sealed by glass frit. The extremity of the tube 5 surrounds the electron gun 6 whose beams illuminate the luminescent phosphor screen 13 through the colour selection mask 8, which is flat here, for example, tensioned between the long sides of the frame 19. Metal supports of the frame/mask assembly maintain this assembly within the tube, the said supports being able to comprise a part 10 welded to the frame and a part forming a spring 11, featuring an opening to co-operate with a lug 12 included in the glass peripheral flange 3.

In the example of prior art shown in FIG. 2, the frame 19 comprises a pair of long sides 9 and a pair of short sides 7, said long and short sides having for example an L-shaped cross-section, the short sides having a face 71 noticeably parallel to the mask. The mask 8, itself of a noticeably rectangular form, is tensioned, then maintained in this state, for example, by welding on the extremity 20 of the said long sides of the frame.

The mask 8 comprises a metal sheet, for example in steel or invar, of a very low thickness in the order of 100 μm. The mask has a central zone 30 pierced with openings generally arranged in columns and a peripheral zone 28 surrounding the central zone 30, peripheral zone comprising for example horizontal 31 and vertical 32 edges not participating in the colour selection.

The cathode ray tube structures using colour selection masks tensioned on the frame assembly have to deal with the vibration problem of this mask, according to the modes that are specific to it, when the said mask is excited by external vibrations, for example mechanical impacts on the tube or sound vibrations coming from loudspeakers arranged near the said tube. These vibrations are shown by movements of the mask following a direction perpendicular to its surface, the distance between the openings of the mask and the screen vary locally according to the amplitude of the vibration of the said mask. The purity of the colours reproduced on the screen is therefore no longer guaranteed, the landing points of the beams on the screen being offset according to the amplitude of the vibration and the zone of the mask that is vibrating; for example, the vibrations of the edges of the pierced part 30 of the mask will be more visible on the screen as this zone is crossed by the electronic beams following incidence angles of a large value.

Moreover, as the mask is arranged within the tube in which a hard vacuum is applied, the vibrations of the mask only dampen very slowly, the energy supplied to the mask having little dissipation means, which increases the visibility of the phenomenon on the screen when the tube is operating.

The same phenomenon can arise with masks formed by pressing then welded to the frame and this especially for tubes with a noticeably flat front face. As the surface of the mask participating in the colour selection follows the internal surface of the front face of the tube, the flatness of the surface of the mask means that this is surface not mechanically rigid and on the contrary sensitive to vibrations in the environment.

Various devices are proposed in the prior art for reducing the vibrations of the mask; for example, the European patent application EP1089311 describes such a device illustrated by FIG. 3, by arranging in the edges of the mask 8, in the non-pierced part 28, hooks 41 crossing the surface of the mask through openings 40 made on this surface. The vibrational energy of the mask is then partially absorbed by the friction of the hooks on the surface of the mask. However, this structure has a certain number of disadvantages:
it is only partially effective as the weight of the hooks are limited by the mechanical fragility of the metal sheet constituting the mask.
the hooks are fitted on the mask which is itself mechanically fragile with the risk of deteriorating this mask

The invention proposes a simple, economic structure that is easy to implement for damping the vibrations of a mask generated by the environment of the tube by installing a damping device on the frame to which the mask is integrated.

FIG. 4 is a top view of a first embodiment of a shadow mask frame assembly 90 according to the invention.

The frame 90 is a noticeably rectangular form and comprises a pair of short sides 100 and a pair of long sides 101. The short sides are of a noticeably L-shaped cross-section and present a first flange 100′ noticeably parallel to the surface of the mask and a second flange 100″ perpendicular to the first and extending toward the screen of the tube.

A cavity is practiced along the short sides 120, noticeably in the middle of the said short sides, realised for example by stamping the flange 100′ parallel to the surface of the mask. This parallelepiped shaped cavity extends along the short side so as to be able to receive a mass 115; the cavity is closed by a cover 112 being able, as illustrated by FIG. 6, to cover the cavity 120 only partially, the opening 111 of the cover 112 being of a smaller dimension than the mass 115 for maintaining this latter in the cavity 120. FIG. 5 shows a cross-section of a plane AA′ perpendicular to the flange 100′ and passing through the middle of the short sides 100, the mass 115 maintained within the cavity 120 by the cover 112.

To make handling the frame/mask assembly simpler and prevent outgrowths hindering this handling by catching hazards, the cavity extends toward the inside of the volume created by the said assembly. In this manner, the surface of the frame/mask assembly opposite the mask remains noticeably flat.

The volume of the cavity once closed by the cover 112 remains slightly greater than the volume of the mass 115 that is contains so that this mass is not immobilised. According to the invention, the mechanical play of the mass 115 in the cavity according to the direction of the longitudinal axis Z of the tube must be at least in the order of 0.5 mm and preferentially approximately 1 mm, for tubes of intermediate dimension, namely with a screen diagonal in the order of 70 cm.

The weight of the mass 115 must be adjusted according to parameters such as the format of the picture screen (4/3 or 16/9), the dimension of the screen, the fact of having a frame/mask system in which the mask is tensioned or not. It has been shown that for the mass 115 to supply the maximum efficiency, it must preferentially have a weight proportional to the weight of the frame/mask assembly. Hence, for a tube of screen diagonal 68 cm, and for which the frame/mask assembly weighs around 2 kg, it is preferable for each short side of the frame to have a mass 115 weighing between 80 and 160 grams, namely between 4% and 8% of the weight of frame/mask assembly according to whether the screen format is 4/3 or 16/9 and/or the frame/mask system is of the tensioned mask type or not.

In a second embodiment of the invention illustrated by FIGS. 7 and 8, the cavity 110 containing the mass 115 is realised by adding on a unit casing 116 containing the said mass and by integrating the said casing by welding it to the frame. The casing 116 can for example comprise two opposing lips 117 folding outwards to allow welding to the flange 100′ and two lips 118 folding inwards so as to support the mass 115 inside the casing before the welding phase on the frame.

The embodiments described herein are not restrictive. It is possible to advantageously arrange not one cavity per side of the frame but several, for example two cavities per side, each containing a mass 115 and symmetrically arranged in relation to the plane containing the main axis Z and passing through the middle of the said side. This more costly structure than that of FIGS. 5 and 7 has the advantage of increasing the friction surfaces of the masses within the cavities and reducing more rapidly the visible effects of the vibrations of the mask. In the same spirit of increasing the surfaces rubbing against each other, it is possible to use not one mobile mass 115 but several separate masses together in the same cavity.

Likewise, it can be advantageous to arrange mobile masses with the cavities located on the long sides of the frame.

1. Cathode ray tube comprising a colour selection mask (8) in the form of a metal sheet, adapted so as to be fixed on a frame assembly noticeably rectangular in shape, the said frame comprising a pair of short parallel sides and a pair long parallel sides,
the frame having at least one pair of parallel sides each comprising at least one cavity within which at least one metal mass is capable of moving.

2. Cathode ray tube according to claim 1, wherein the mask is formed by pressing.

3. Cathode ray tube according to claim 1 wherein the mask is maintained in tension by the frame assembly according to at least one direction.

4. Cathode ray tube according to claim 1 wherein the cavity is realised by stamping the material constituting the side of the frame.

5. Cathode ray tube according to claim 1 wherein the cavity is constituted by an additional unit integrated on the side of the frame.

6. Cathode ray tube according to claim 1 wherein the weight of the moving masses on each of the parallel sides comprises between 4% and 8% of the frame/mask assembly.

7. Cathode ray tube according to claim 1 wherein several masses mobile in relation to each other are arranged in the same cavity.
